(19) United States
(12) Patent Application Publication
(10) Pub. No.: US 2013/0327127 A1
(43) Pub. Date: Dec. 12, 2013

(54) LEAKAGE DETECTION DEVICE AND AIRCRAFT WITH A BLEED AIR SYSTEM AND AT LEAST ONE LEAKAGE DETECTION DEVICE

(71) Applicants: Terry OSTHUS, Auburn, WA (US); Stephan OETTLE, Bremen (DE)

(72) Inventors: Terry OSTHUS, Auburn, WA (US); Stephan OETTLE, Bremen (DE)

(73) Assignee: AIRBUS OPERATIONS GMBH, Hamburg (DE)

(21) Appl. No.: 13/492,360

(22) Filed: Jun. 8, 2012

(51) Int. Cl. G01M 3/04

(52) U.S. Cl. 73/40

(57) ABSTRACT

A leakage detection device comprises a cuff of an elastic material for being circumferentially wrapped around a region of a fluid-carrying conduit, wherein the cuff has an inner surface and an outer surface, through which at least one opening extends. At least one holder that comprises at least one guide element for guiding a measuring element over the opening is arranged at the edge of the opening. In this way, the measuring element can be positioned at a predetermined radial distance from the opening.

### TECHNICAL FIELD

The technical field pertains to a leakage detection device for a fluid-carrying conduit and to a bleed air system for an aircraft with at least one bleed air conduit and at least one leakage detection device arranged thereon.

### BACKGROUND

Existing leakage detection devices according to the prior art make it possible to detect a leak in a fluid conduit if the fluid conduit carries a fluid that is heated in comparison with its surroundings. A leakage volume flow being created can be directed at a warning wire, the electric properties of which are monitored, by enclosing a leakage-prone region and creating a defined outlet opening. Significant changes of the electric properties are indicative of a leak.

It is known to provide bleed air conduits of aircraft with warning wires in order to detect leaks. The warning wires are usually realized in the form of a coaxial cable with a central conductor and a sheath with thermally sensitive eutectic salt as insulation. If significant heating occurs at a point along the warning wire due to a leak, the resistance of the eutectic salt drops within this heated section and ensures that a voltage applied between the outer sheath and the central conductor creates a current flow that is measured by a control unit. A device of this type is described, for example, in DE 10 360 485.

In addition, U.S. Pat. No. 7,155,961 B2 shows a leakage detection device, in which a cuff of flexible material is placed around a section of a bleed air conduit of an aircraft, wherein the cuff comprises an opening, through which a leakage air mass flow can pass, and warning wires are arranged on the opening outside the bleed air conduit in order to detect the escape of hot bleed air. In addition, other objects, desirable features and characteristics will become apparent from the subsequent summary and detailed description, and the appended claims, taken in conjunction with the accompanying drawings and this background.

### SUMMARY

The routing of warning wires on the outlet openings of cuffs can potentially be optimized with respect to the vibrations or inertial forces occurring in a commercial aircraft.

Consequently, according to various aspects, provided is a leakage detection device, by means of which the most precise and reliable leakage detection possible can be realized on a bleed air conduit or another conduit that carries a heated fluid such that the probability of triggering a false alarm is particularly low.

According to various aspects, the leakage detection device comprises a cuff of an elastic material for being circumferentially wrapped around a region of a conduit, wherein the cuff has an inner surface and an outer surface, through which at least one opening extends, and wherein at least one holder arranged on the outer surface at the edge of the opening comprises at least one guiding device for guiding a measuring element over the opening.

In the context of the present teachings, a conduit should be interpreted as an arrangement of fluid-carrying devices that may comprise straight, bent and flexible pipelines, as well as hoses, sleeves, flanges, couplings and other devices. The present disclosure therefore is not limited to the arrangement of a leakage detection device on only one of these devices.

The cuff of the leakage detection device thusly is flexible and can be placed onto a conduit to be monitored by means of wrapping. In order to allow the subsequent attachment to a fluid-carrying conduit, the cuff is generally realized in a detachable fashion and may comprise a Velcro fastener in an overlapping region for fixing the cuff on the conduit, wherein it would also be conceivable to utilize gluing in an alternative exemplary embodiment or, according to yet another alternative exemplary embodiment, to place adhesive tapes over the cuff edges and the fluid-carrying conduit or to arrange Velcro strips on the edges of the cuff. The cuff generally comprises a bulgy insulating material that encloses air and is realized, for example, in the form of glass wool, wherein this insulating material is generally surrounded by a water-tight sheath. Depending on the intended use such as, for example, the monitoring of conduits that carry bleed air, the cuff is realized such that it is resistant to temperatures up to approximately 200° C., hardly inflammable and has self-extinguishing properties.

The wrapping includes the placement of the cuff onto the conduit in such a way that the cuff circumferentially overlaps on its ends and a closed circumference is created. The cuff therefore should be dimensioned such that it is longer than the circumference of the respective conduit in one direction in space. A leak occurring underneath this cuff causes the escaping air to spread out between the air conduit and the cuff and to subsequently flow outward through the nearest available opening, wherein this opening includes the opening arranged in the cuff if the cuff is circumferentially sealed.

The at least one holder arranged on the outer side of the cuff makes it possible to directly guide at least one measuring element over the opening at a predetermined radial distance such that fluid escaping from the conduit directly acts upon the at least one measuring element. The measuring element generally includes a warning wire that is surrounded by eutectic salt and a metallic sheath similar to a coaxial cable.

The arrangement of the holder on the outer side of the cuff provides the particular advantage that the at least one measuring element is reliably arranged at a predetermined distance above the opening such that the conduit can also be reliably monitored for leaks under the vibrations or inertial forces that occur during the utilization in an aircraft.

According to various exemplary embodiments, the holder is mounted on the cuff. Since any contact between the holder and a surface of the fluid-carrying conduit to be monitored can be avoided, the opening in the cuff can lie underneath the measuring element. It is therefore not required to supplement the cuff with an opening for leading through the holder. The measuring element is guided at a defined distance above the opening. In addition, the installation of a cuff with a holder directly mounted thereon is much simpler than the placement of a cuff around a fluid-carrying conduit, on which holders are already mounted. The monitoring reliability furthermore is significantly increased.

In one of various exemplary embodiments, the at least one holder is glued to the outer side of the cuff. This results in a reliable bonded connection that tolerates vibrations and inertial forces. If the leakage detection device should be used on a bleed air conduit of an aircraft, the adhesive used should be temperature-resistant, generally up to approximately 200° C. In this case, an adhesive that is resistant to temperatures up to approximately 135° C. may be based on a two-component epoxy adhesive. However, silicon-based adhesives may be more suitable for temperatures up to approximately 200° C.

In one of various exemplary embodiments, the holder is arranged on a mounting band that extends over the outer contours of the holder in at least one dimension and is sewn to the outer surface of the cuff. The arrangement of a band including a cloth or another flexible, pliable material makes it possible to restrict the freedom of motion of the outer surface of the cuff much less in a region underneath the holder, for example, because only the regions of the mounting band that extend over the outer contour of the holder need to be sewn on and the space between the holder and the outer surface does not comprise any connecting means such as an adhesive or a seam.

The holder generally comprises a lower part and a holding part that are fixed on one another such that they enclose the mounting band. In this case, the holding part forms part of the holder that fulfills the technical function of holding and guiding the measuring element. The lower part forms part of the holder that lies on the cuff. The mounting band between the two holder parts contributes to a sandwich-like design.

In one exemplary embodiment, the mounting band comprises the same material as the outer side of the cuff. The cuff may comprise a plastic film, a woven plastic fabric, a cloth, an impregnated cloth or other materials suitable for tolerating the corresponding temperature range. Due to the identical material properties, the mounting band can be very easily sewn or glued to the cuff.

In one of various exemplary embodiments, the holder is detachably arranged on the cuff. This can be realized, e.g., with a Velcro fastener, generally with a band of loops and a band of hooks, for mounting the holder on the cuff, wherein the band of loops is typically arranged on the holder. The band of hooks may be arranged on the cuff by means of a bonded or sewn connection. In the context of the preceding description, the band of loops can be interpreted as a mounting band that may also be fixed on the holder like the other mounting bands. In addition to the simple attachment of a Velcro fastener, it is advantageous that a band of loops or a band of hooks may have a higher strength than the sheath material of the cuff. There also exist alternative Velcro fasteners, in which bands of the same type are connected to one another, wherein these Velcro fasteners naturally can also be used for detachably mounting the holder. In addition, all known snap-type connections, click-type connections, button connections and latching connections can be used, such as those known from applications on textiles.

In another of various exemplary embodiments, the Velcro fastener extends over at least about 50% of the circumference of the cuff. This results in a reliable mechanical connection between the holder and the cuff that can be easily produced.

According to various exemplary embodiments, the mounting band is realized in a self-adhesive fashion. This makes it possible to retrofit conduits in a simple fashion if the cuffs should not be removed from the conduit to be monitored.

In addition, the holder generally may be detachably arranged on the cuff such that it is also possible to subsequently attach the holder or to readjust the position thereof.

In one of various exemplary embodiments, the holder comprises a metallic material and comprises at least one mounting surface, wherein the at least one guide element extends outward from the side of the holder that lies opposite of the at least one mounting surface. The at least one mounting surface of the holder defines the underside thereof and serves for attaching the holder to the outer side of the cuff. The guide element furthermore is dimensioned in such a way that the respective measuring element is guided at a safe distance from the mounting surface.

According to various aspects, the at least one guide element is designed for holding the measuring element. In this case, the guiding function should merely be interpreted as the specification of a position and an orientation. The holding function may furthermore prevent the respective measuring element from sliding out or moving in the measuring element. The holding function may be realized with a positive or non-positive connection. A clamping connection may be suitable in this respect, but it needs to be observed that the clamping force does not compress a coaxial arrangement including a wire, eutectic salt and a metallic sheath to such a degree that it causes the wire to contact the sheath.

In one of various exemplary embodiments, the mounting band extends over the outer contours of the holder in at least two lateral directions. Consequently, the holder can be very reliably arranged on the outer surface of the cuff by sewing on the mounting band on both sides such that a precise, reliable and constant orientation of the measuring element can be achieved above the opening.

In one of various exemplary embodiments, the at least one guide element is groove-shaped, wherein the groove shape defines the orientation of a measuring element. The reliable orientation of the measuring element therefore is additionally improved.

According to various exemplary embodiments, the mounting band extends over the outer contours of the holder in two lateral directions, wherein the orientation of the mounting band extends orthogonal to the orientation of the groove-shaped guide element. Consequently, the mounting band can be sewn on laterally of the guided measuring element such that the lateral guidance of the measuring element above the opening is also ensured during vibrations.

In one of various exemplary embodiments, the holder has a width b, wherein the width of the mounting band exceeds the width b by at least about 50%. The thusly created mounting straps extending over the outer contours of the holder therefore suffice for reliably mounting the holder on the outer surface of the cuff.

In one of various exemplary embodiments, the cuff is realized in a thermally insulating fashion, wherein an insulating material is arranged between the inner surface and the outer surface of the cuff. This insulating material may comprise, for example, glass wool or another material that encloses air and significantly restricts the heat conduction or the heat transmission, respectively.

In another exemplary embodiment, the holder is fixed on the mounting band with the aid of a positive connection. The positive connection may comprise, e.g., a riveted connection or a sewn connection.

According to various exemplary embodiments, the guide element comprises a longitudinally slotted bushing of an elastic material. This bushing can also be subsequently attached to or clamped on a warning wire or the like.

The holder generally comprises a receiving surface for accommodating the bushing and a hold-down device, wherein the hold-down device can be mounted on the holder in such a way that the bushing is clamped between the receiving surface and the hold-down device.

In one exemplary embodiment, the holder comprises a metallic sheet that makes it possible to produce a reliable and durable connection with the measuring element.

In one exemplary embodiment, the holder comprises a pliable textile material, wherein the textile material may comprise natural or synthetic fibers. The manufacture of the holder therefore can be additionally simplified and the weight of the holder is relatively low such that it is particularly suitable for use in an aircraft.

In one of various exemplary embodiments, the holder comprises two guide elements that make it possible to guide two parallel measuring elements above the opening of the cuff to provide additional reliability for the leakage detection device.

The present teachings furthermore pertain to a bleed air system for an aircraft with at least one bleed air conduit and at least one leakage detection device of the above-described type arranged thereon. In this case, the bleed air conduit may comprise straight or bent sections. It is particularly advantageous to arrange a leakage detection device on bent and flexible conduit sections that have a certain freedom of motion, for example, similar to a bellows.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIGS. 1a and 1b show top views of a leakage detection device according to the various teachings of the present disclosure;

FIG. 1c illustrates an exemplary holder according to the various teachings of the present disclosure;

FIG. 1d illustrates the leakage detection device positioned about a conduit according to various embodiments;

FIG. 1e illustrates another exemplary embodiment of the leakage detection device; and

FIG. 2 shows an aircraft with a bleed air system and a leakage detection device arranged thereon.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

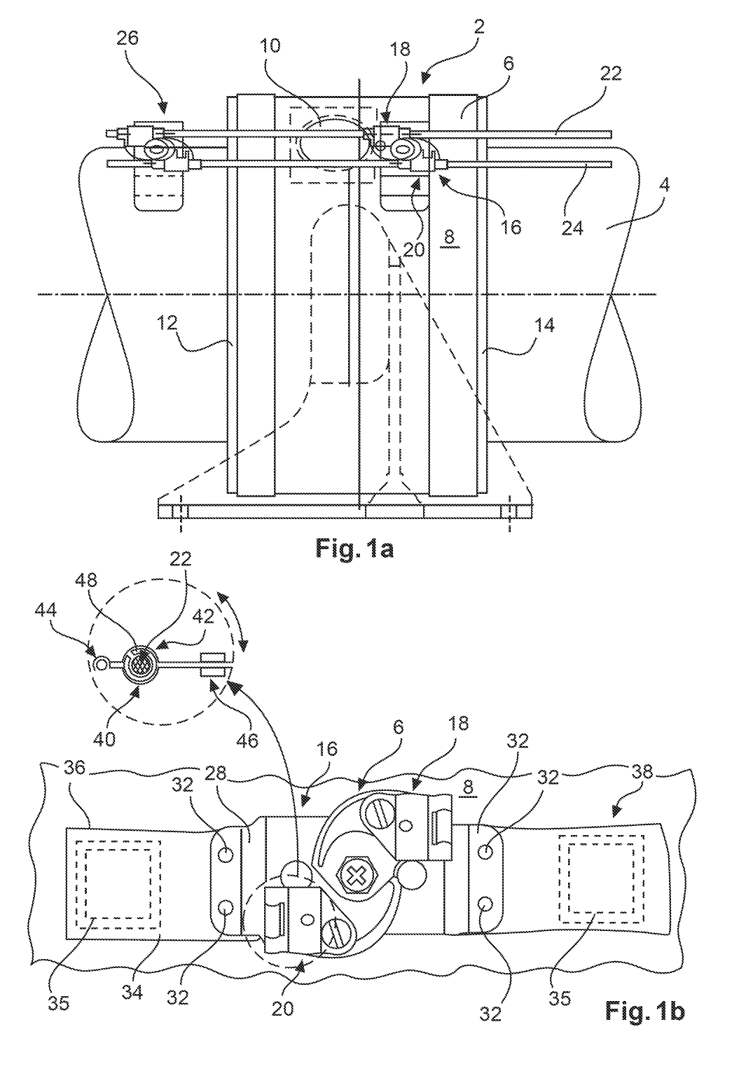

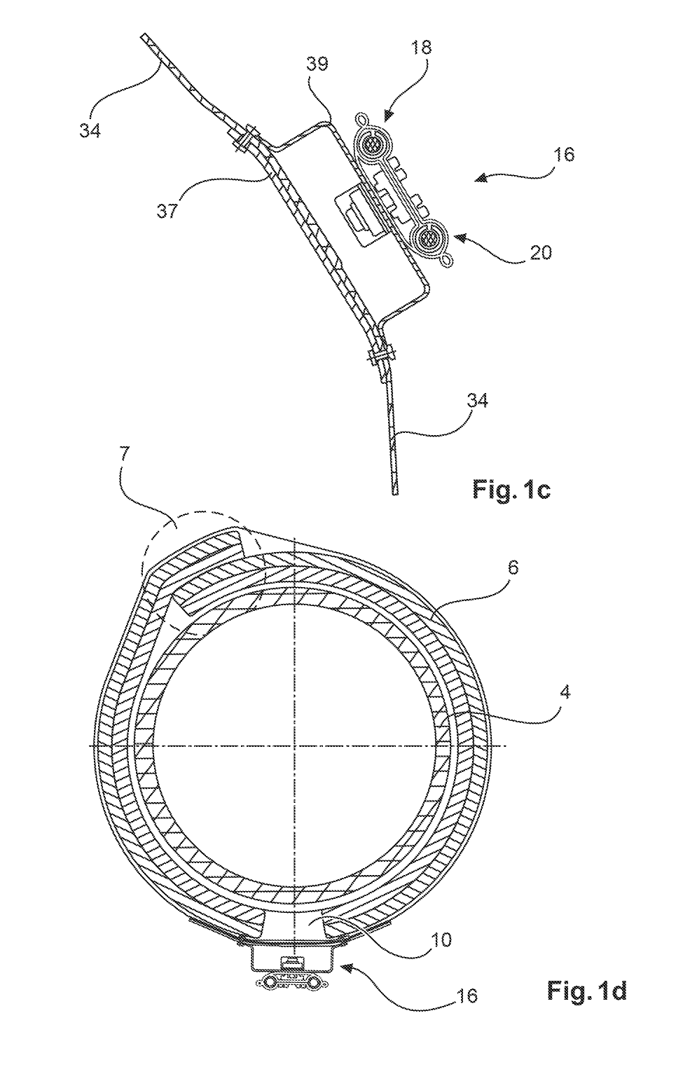

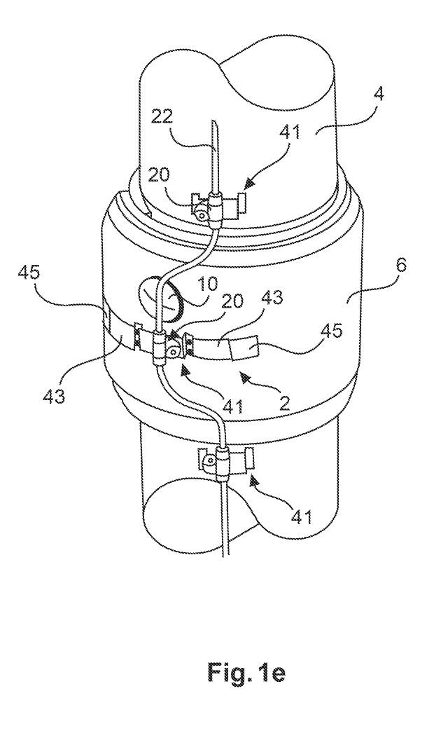

FIG. 1a shows a leakage detection device 2 according to various exemplary embodiments of the present disclosure that is arranged on a fluid-carrying conduit 4. The leakage detection device 2 comprises a cuff 6 that is circumferentially wrapped around the conduit 4 such that a closed circumference is created. In this case, the cuff 6 has an outer surface 8 and an inner surface that is not visible in this illustration and connected to the outer surface of the conduit 4. The cuff 6 furthermore comprises an opening 10 that extends from the inner surface to the outer surface 8. A leak developing in the conduit 4 underneath the cuff 6 results in the escape of air that consequently spreads out between the conduit 4 and the inner surface of the cuff 6 before it discharges through the opening 10. This routing of the flow is realized in a generally reliable fashion if the axially extending edges 12 and 14 are in flush contact with the conduit 4, but this is not imperative and may be avoided in order to allow a thermal expansion of the conduit 4, if desired.

A holder 16 situated on the outer surface 8 guides two warning wires 22 and 24 with the aid of two guide elements 18 and 20. The warning wires 22 and 24 may be realized in the form of a coaxial arrangement of a wire that is surrounded by eutectic salt and a metallic sheath. If the composition of the eutectic salt is chosen accordingly, heat acting upon the warning wire leads to a drastic drop of the local electrical resistance that can then be detected in the form of a short circuit between the wire and the sheath. This requires the presence of a heated fluid that escapes from the opening 10 and acts upon the respective warning wires 22 and 24.

The peculiarity of the leakage detection device 2 according to various embodiments can be seen in that the holder 16 is directly arranged on the outer surface 8 of the cuff 6 and directly guides the warning wires 22 and 24 at a predetermined distance from the opening 10 at the edge of the opening 10. This can prevent the warning wires 22 and 24 above the cuff 6 being moved away from the opening 10 due to vibrations or directly contacting the cuff 6 such that a false alarm may be triggered.

In addition, another holder 26 may be arranged outside the cuff 6, wherein this additional holder is, for example, subject to the same fundamental design principles as the holder 16 as described below with reference to FIG. 1b.

The exemplary holder 16 according to FIG. 1b comprises a metallic material that, for example, is realized in the form of a metal sheet with several chamfers. Two strap-shaped mounting surfaces 28 and 30 extend outward laterally of the holder 16 and respectively comprise bores 32 that make it possible to produce, for example, a riveted connection with a mounting band 34. The mounting band 34 may comprise a pliable textile material, wherein the mounting band 34 substantially protrudes laterally over the mounting straps 28 and 30. The thusly created straps 36 and 38 can be sewn to the outer surface 8 of the cuff with the aid of sewn connections 35.

The holder furthermore comprises two guide elements 18 and 20 that are also realized, for example, in the form of chamfered metal sheets and comprise several parts in the variation shown such that a warning wire 22 or 24 can be placed on a receiving surface 40 and a hold-down device 42 that can be attached to the receiving surface can clamp the respective warning wire 22 or 24 in position. For example, a combination of a receiving surface 40 and a hold-down device 42 may in a mounted state form a circular holding cross section that corresponds to the cross section of the respective warning wires 22 and 24. In the examples shown, the hold-down device 42 is pivotably supported by means of a hinge 44, wherein the hold-down device 42 is rigidly fixed relative to the receiving surface 40 by means of a screw connection 46.

In order to further protect the respective warning wires 22 and 24 to be guided, a bushing 48 that is slotted on one side and includes an elastic material may be arranged between the receiving surface 40 and the hold-down device 42, wherein said bushing can be subsequently pushed or clipped on a respective warning wire 22 or 24 and contacts the hold-down device 42, as well as the receiving surface 40, in a flush fashion during the mounting of the hold-down device 42. Due to the utilization of a residual elasticity of the bushing 48, a sensitive warning wire can also be reliably held by means of a non-positive connection.

According to the illustration in FIG. 1c, a holder 16 may also comprise an upper holding part 39 and a lower part 37 that enclose the mounting band 34 due to a riveted connection produced through the bores 32. This sandwich-like design allows an advantageous force transmission into the mounting band 34 because tensile forces can also be transmitted into the mounting band 34 via a non-positive clamping connection between the holding part 39 and the lower part 37.

FIG. 1d discloses the wrapping of a cuff 6 around a conduit 4 such that an overlapping region 7 is created, wherein said overlapping region causes escaping fluid to reach the opening 10 of the cuff 6 as reliably as possible.

FIG. 1e discloses a variation, in which a cuff 6 is arranged on a conduit 4, wherein the outer side 8 of the cuff 6 is equipped with a holder 41 that comprises one the guide element 20. A Velcro fastener including a band of loops 43 and a band of hooks 45 is used for mounting the holder 41. In this case, the band of hooks 45 may be bonded or sewn to the outer side 8 of the cuff 6. The band of loops 43 can be very easily pressed onto the band of hooks 45 in order to achieve a sufficiently reliable connection.

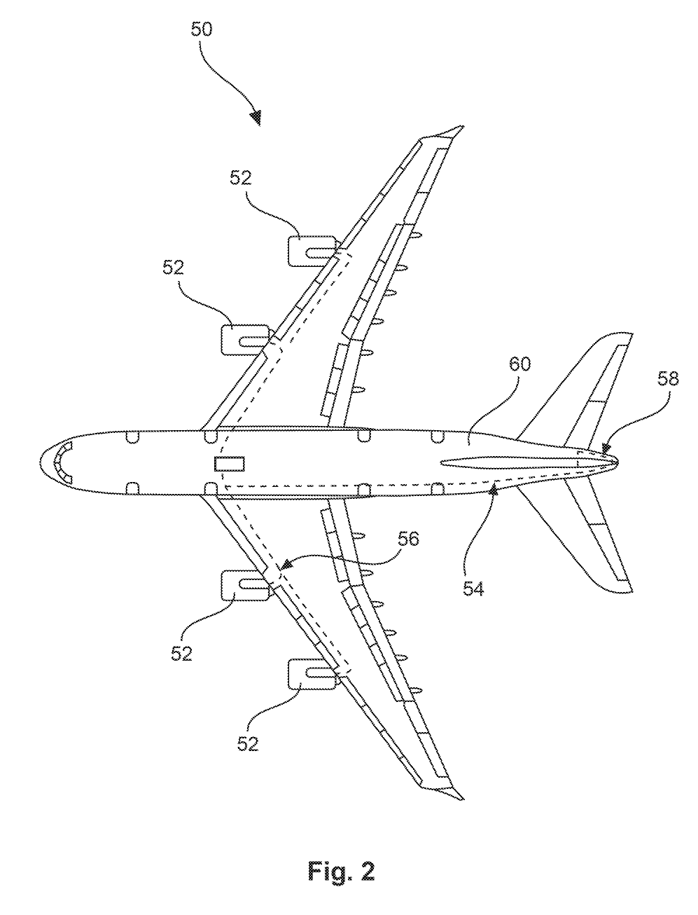

FIG. 2 shows an aircraft 50 comprising engines 52 and an auxiliary power unit 58 that deliver bleed air with a correspondingly high temperature from one or more compressor stages. Bleed air conduits 54 and 56 that deliver bleed air to devices that consume bleed air may contain straight sections and bent sections, wherein the latter may be realized similar to metal bellows in order to permit thermal expansions and compensate manufacturing tolerances. Due to the flexibility and the resulting deformability, these deflections may develop leaks that can be detected with the aid of leakage detection devices 2 according to the present disclosure. However, it would also be possible, in principle, to monitor all sections of bleed air conduits 54 and 56 with such a leakage detection device 2. In one example, the region of the fuselage 60 of the aircraft 50 that accommodates the auxiliary power unit 58 may be monitored with the aid of a leakage detection device 2 to aid in preventing the leakage of bleed air in a pressurized region of the aircraft 50.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A leakage detection device comprising:
a cuff of an elastic material couplable circumferentially around a region of a fluid-carrying conduit, the cuff having an inner surface and an outer surface, through which at least one opening extends; and
wherein at least one holder that comprises at least one guide element that guides a measuring element over the opening is mountable on the outer surface at the edge of the opening.

2. The leakage detection device of claim 1, wherein the at least one holder is mounted on the cuff only.

3. The leakage detection device of claim 1, wherein the at least one holder is bonded to the outer side of the cuff.

4. The leakage detection device of claim 1, wherein the holder is arranged on a mounting band that extends over the outer contours of the holder in at least one dimension and is sewn to the outer surface of the cuff.

5. The leakage detection device of claim 1, wherein the holder is detachably mounted on the cuff.

6. The leakage detection device of claim 1, wherein the holder comprises a metallic material and has at least one mounting surface, and wherein the at least one guide element extends outward from the side of the holder that lies opposite of the at least one mounting surface.

7. The leakage detection device of claim 1, wherein the cuff is detachably fixable on a fluid-carrying conduit.

8. The leakage detection device of claim 1, wherein the at least one guide element is realized in a groove-shaped fashion, and wherein the groove shape defines the orientation of a measuring element.

9. The leakage detection device of claim 3, wherein the mounting band extends over the outer contours of the holder in two lateral directions, and wherein the orientation of the mounting band extends orthogonal to the orientation of the groove-shaped guide element.

10. The leakage detection device of claim 1, wherein the holder comprises a receiving surface that accommodates a longitudinally slotted bushing and a hold-down device, and wherein the hold-down device is mountable on the holder in such a way that the bushing is clamped between the receiving surface and the hold-down device.

11. The leakage detection device of claim 1, wherein the holder comprises a metallic sheet that makes it possible to produce a reliable and durable connection with the measuring element.

12. The leakage detection device of claim 1, wherein the holder comprises a pliable textile material.

13. The leakage detection device of claim 1, wherein the holder comprises two guide elements that make it possible to guide two parallel measuring elements above the opening of the cuff.

14. An aircraft with a bleed air system including at least one bleed air conduit and at least one leakage detection device comprising:
a cuff of an elastic material couplable circumferentially around a region of a fluid-carrying conduit, the cuff having an inner surface and an outer surface, through which at least one opening extends; and
at least one holder,
wherein the at least one holder includes at least one guide element that guides a measuring element over the opening and is mountable on the outer surface at the edge of the opening.

15. The aircraft of claim 14, wherein at least one leakage detection device is arranged on a conduit in a non-pressurized region of the fuselage of the aircraft.
